(19) United States
(12) Patent Application Publication
(10) Pub. No.: US 2011/0018337 A1
(43) Pub. Date: Jan. 27, 2011

(54) BRAKING SYSTEM WITH LINEAR ACTUATOR

(75) Inventors: John C. King, Layton, UT (US); Mark A. Shea, Cottleville, MO (US)

Correspondence Address: FITCH EVEN TABIN & FLANNERY, 120 SOUTH LASALLE STREET, SUITE 1600, CHICAGO, IL, 60603-3406, US

(73) Assignee: GENERAL ATOMICS

(21) Appl. No.: 12/812,030

(22) PCT Filed: Jan. 12, 2009
(86) PCT No.: PCT/US09/30782

§ 371 Date: Sep. 22, 2010

Related U.S. Application Data
(60) Provisional application No. 61/020,679, filed on Jan. 11, 2008.
(60) Provisional application No. 61/031,650, filed on Feb. 26, 2008.

(51) Int. Cl. B64C 25/46; B60T 8/36; B60T 8/176; B64C 25/42; B60T 13/10; B60T 13/66

(52) U.S. Cl. 303/13; 303/119.1; 303/158

(57) ABSTRACT

Various brake control systems and methods are provided herein. In one implementation, a brake pressure control system having a shutoff valve (24) in a hydraulic conduit (26, 30) between a pressure origination source (16, 18) and a wheel brake (20), the shutoff valve selectively isolates the pressure origination source from the brake responsive to an indication that a wheel associated with the brake meets a skid condition, and an actuator assembly (28) comprising an actuator (34) that regulates fluid brake pressure after the shutoff valve isolates the pressure origination source from the brake. The actuator assembly operates independently of the shutoff valve and is coupled to the hydraulic conduit between the shutoff valve and the brake. The actuator assembly also effects displacement of the actuator for increasing and decreasing brake pressure. A controller (44) determines if the skid condition has been reached and controls the shutoff valve and the actuator assembly based upon the skid condition.

This application claims the benefit of U.S. Provisional Application No. 61/020,679, filed Jan. 11, 2008 (Docket No. 92003/8531) and U.S. Provisional Application No. 61/031,650, filed Feb. 26, 2008 (Docket No. 92014/8531), both of which are incorporated in their entirety herein by reference.

### BACKGROUND OF THE INVENTION

1. Field of the Invention

The present invention relates generally to braking systems, and more specifically to braking systems for aircraft. Even more specifically, the present invention relates to a braking system for aircraft using a linear actuator.

2. Discussion of the Related Art

Anti-skid braking control systems have been in widespread use for many years. Such braking control systems are implemented in various applications including vehicles and aircraft. In the simplest sense, an anti-skid braking control system compares the speed of an aircraft, for example, derived from a wheel speed sensor (and wheel/tire radius) to the aircraft speed typically derived from a secondary or reference source. If the wheel is determined to be skidding or approaching a skid threshold, then brake pressure applied to the wheel is released and the wheel is allowed to spin back up to the appropriate speed. In this manner, anti-skid control is achieved by controlling the hydraulic pressure in the braking circuit in three modes; the pressure relieving mode, the constant pressure mode, and pressure increasing mode.

It is common for aircraft to implement anti-skid control systems using a central hydraulic fluid supply system. This is typical because of the use of hydraulic fluid supply for other systems on the airplane in addition to the relatively high volume of hydraulic fluid that is needed to drive various components of a conventional anti-skid control system. One drawback with this arrangement is that increasing numbers of modern aircraft either do not have a central hydraulic system or the hydraulic system cannot be easily adapted to additionally control an anti-skid control system.

Additionally, braking is typically accomplished by a pilot of an aircraft as a result of the pilot applying an angular displacement to the brake pedal or pedals. In other words, the pilot must rotate the pilot's ankle forward or backward on the pedal. The pivoting of the pedal generally causes a master cylinder to displace fluid volume which in turns applies fluid pressure to a brake coupled to a wheel of the aircraft. Many brake systems require a large degree of ankle rotation by the pilot to displace enough fluid to fill the brake and effect the necessary braking, and for many pilots, as the pedal angle increases, it is more difficult to generate foot pressure. It can even result in requiring pumping of the pedal to displace enough fluid. If the master cylinder is sized to allow adequate fluid volume, it is sometimes difficult to get adequate pressure at the same time. Furthermore, the pilot is often required to maintain the ankle at a fully braked position in order to maintain the aircraft in a stopped position. Both conditions, large pedal displacements and holding the depressed pedal, can lead to discomfort of the pilot and reduce the ability to generate high pressures.

### SUMMARY OF THE INVENTION

Several embodiments of the invention advantageously address the needs above as well as other needs by providing a brake pressure control system.

In one embodiment, the invention can be characterized as a brake pressure control system having a shutoff valve located in a hydraulic conduit between a pressure origination source and a wheel brake, wherein the shutoff valve is configured to selectively isolate the pressure origination source from the wheel brake responsive to an indication that a wheel associated with the wheel brake meets a skid condition, and an actuator assembly comprising an actuator displaceable to regulate fluid brake pressure within the hydraulic conduit after the shutoff valve isolates the pressure origination source from the wheel brake, wherein the actuator assembly is configured to operate independently of the shutoff valve and is coupled to the hydraulic conduit between the shutoff valve and the wheel brake. The actuator assembly is also structured to effect displacement of the actuator for increasing and decreasing the brake pressure. The system further includes a controller coupled to the shutoff valve and the power source and configured to determine if the skid condition has been reached, wherein the controller is further operable to control the shutoff valve and the actuator assembly based upon the skid condition.

In another embodiment, the invention can be characterized as a method for controlling brake pressure in a brake system comprising a shutoff valve located in a hydraulic conduit between a pressure origination source and a wheel brake. The method includes determining that a wheel associated with the wheel brake meets a skid condition, and isolating the pressure origination source from the wheel brake responsive to the determining of the skid condition. After the isolating, and independent of the isolating, the method includes reducing brake pressure in the conduit between the shutoff valve and the wheel brake, and terminating the isolating of the pressure origination source from the wheel brake upon determining that the wheel no longer meets the skid condition.

In yet another embodiment, the invention can be characterized as a brake pressure control system having a shutoff valve located in a hydraulic conduit between a pressure origination source and a wheel brake, wherein the shutoff valve is configured to selectively isolate the pressure origination source from the wheel brake responsive to an indication that a wheel associated with the wheel brake meets a skid condition, and an actuator assembly coupled to the shutoff valve via a portion of the hydraulic conduit and comprising an actuator displaceable to regulate fluid brake pressure within the hydraulic conduit after the shutoff valve isolates the pressure origination source from the wheel brake. The actuator assembly is also structured to effect displacement of the actuator for increasing and decreasing the brake pressure. The system further includes a controller coupled to the shutoff valve and the power source and configured to determine if the skid condition has been reached, wherein the controller is further operable to control the shutoff valve and the actuator assembly based upon the skid condition.

In still yet another embodiment, the invention can be characterized as a brake pressure control system for de-spin braking in an aircraft. The system includes an actuator assembly comprising an actuator configured to couple to a hydraulic conduit between a pressure origination source and a wheel brake, and a restrictor configured to at least partially restrict fluid flow in the hydraulic conduit between the actuator assembly and a pressure origination source, wherein the actuator assembly is structured to effect displacement of the actuator for increasing the brake pressure. The system further includes a controller coupled to the power source configured to cause the actuator assembly to create a transient increase in the brake pressure toward the wheel brake responsive to a wheel de-spin condition associated with the wheel brake.

In one embodiment, the invention can be characterized as a method for providing touchdown protection for an aircraft with a brake system comprising a shutoff valve located in a hydraulic conduit between a pressure origination source and a wheel brake. The method includes isolating the pressure origination source from the wheel brake prior to detecting a touchdown condition of the aircraft, determining that the aircraft meets the touchdown condition, and deactivating the isolation of the pressure origination source from the wheel brake upon the determining that the aircraft meets the touchdown condition.

In a further embodiment, the invention can be characterized as a brake control system, comprising: a wheel brake having a brake volume; a hydraulic conduit containing a fluid and coupled to the wheel brake; a pressure origination source adapted to effect a first displacement of a volume of the fluid at a first location in response to a mechanical request for braking from a user via a brake pedal; a first sensor configured to output a first indication relating to the mechanical request for braking; an actuator assembly coupled to the hydraulic conduit and comprising an actuator, wherein the actuator assembly is structured to effect movement of the actuator for displacing the fluid; and a controller coupled to the actuator assembly and the first sensor, wherein the controller is adapted to determine if the user is requesting braking and the brake volume is not full based at least in part on the first indication, wherein the controller is further adapted to effect operation of the actuator assembly causing the movement of the actuator to effect a second displacement of volume of the fluid at a second location while the pressure origination source effects the first displacement to provide volume displacement assistance for a given mechanical request for braking.

In another embodiment, the invention can be characterized as a method for braking in a brake control system comprising the steps: displacing a volume of a fluid contained in a hydraulic conduit at a first location in response to a mechanical request for braking of a wheel brake from a user via a brake pedal; sensing a first indication relating to the mechanical request for braking; determining the presence of the mechanical request for braking and whether a brake volume of the wheel brake is not full based at least in part on the first indication; moving, responsive to the determining step, an actuator of an actuator assembly coupled to the hydraulic conduit; and additionally displacing the volume of the fluid contained in the hydraulic conduit at a second location while displacing the volume of the fluid at the first location to provide volume displacement assistance for the mechanical request for braking.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a schematic diagram depicting an anti-skid control system implemented with various aircraft components, in accordance with an embodiment of the present invention.

FIG. 2 is a flowchart depicting a method for controlling brake pressure in a brake system, in accordance with an alternative embodiment of the present invention.

FIG. 3 is a flowchart depicting a method for performing aircraft wheel de-spin at takeoff, in accordance with another embodiment of the present invention.

FIG. 4 is a block diagram depicting a bypass check valve, which includes a restrictor, located in a third conduit portion according to one embodiment.

FIG. 5 is a block diagram depicting a restrictor implemented separate from a bypass check valve according to another embodiment.

FIG. 6 is a flowchart depicting a method for providing touchdown protection for an aircraft with a brake control system according to a further embodiment.

FIG. 7 is a schematic diagram depicting a volume assisted brake control system implemented with various aircraft components, in accordance with another embodiment of the invention.

FIG. 8 is a diagram illustrating the foot position of the pilot while operating the volume assisted brake control system in accordance some embodiments.

FIG. 9 is a graph illustrating the reduction in pedal angle using the volume assisted brake control system in accordance with some embodiments.

FIG. 10 is a schematic diagram depicting an alternative volume assisted brake control system implemented with various aircraft components, in accordance with another embodiment of the invention.

FIG. 11 is a flowchart depicting a method for volume assisting the pilot in braking an aircraft in accordance with one embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

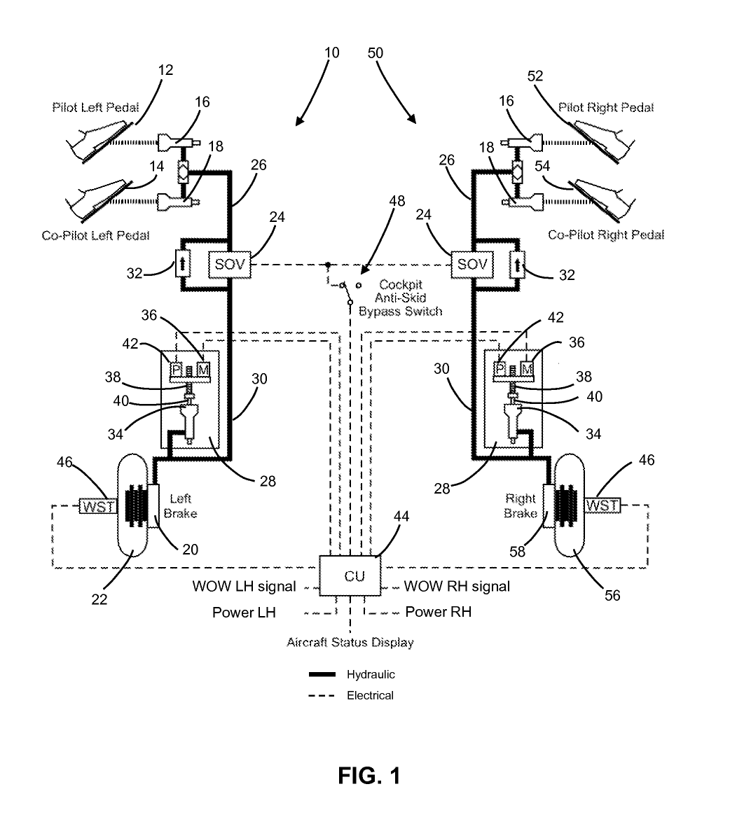

FIG. 1 is a schematic diagram depicting a control system implemented with various aircraft components, in accordance with an embodiment of the present invention. In particular, the control system includes a first brake pressure control system 10 and a second brake pressure control system 50.

In a typical embodiment in which two aircraft brakes are controlled, the first and second control systems 10, 50, usually include the same or similar components. Accordingly, further discussion primarily relates to first brake pressure control system 10, but such description applies equally to second brake pressure control system 50. It is noted that the figures and descriptions herein arbitrarily use dual master cylinders as the pressure origination source. The functionality and benefits of some embodiments also apply for any other pressure origination source including single master cylinders, alternate dual master cylinder arrangements, or even metered pressure from a central hydraulic system. It is also understood that the both control systems 10 and 50 can have separate fluid reservoirs.

With regard to first brake pressure control system 10, left pedals 12, 14 are shown coupled (mechanically and/or electrically) to separate master cylinders 16, 18. Left pedal 12 is shown manipulated by the pilot and left pedal 14 is shown manipulated by a co-pilot. In a typical manual braking procedure, operation of either or both of the left pedals causes pressure to build in left brake 20, thus effecting braking of left wheel 22.

Both master cylinders 16, 18 are shown coupled to shutoff valve 24 via first conduit portion 26. The pedal driven master cylinders are typically selected to match the volume characteristics of left brake 20 and an electromechanical actuator (EMA) implemented in actuator assembly 28. If desired, each master cylinder may include an integral fluid reservoir.

Shutoff valve 24 is in turn coupled to left brake 20 via second conduit portion 30. The shutoff valve is usually implemented as a normally open valve permitting hydraulic flow in both directions, allowing the system to function as a master cylinder braking system. When a developing tire skid of left wheel 22 is detected, for example, the shutoff valve closes to effectively isolate pressure at left brake 20. Accordingly, shutoff valve 24 serves as an isolation valve that selectively isolates the pressure origination source (e.g., master cylinders 16, 18) from left brake 20. One purpose for providing this isolation after anti-skid control is active is to prevent any additional pressure applied by the pilot or co-pilot to reach left brake 20. Another reason is that the performance of actuator assembly 28 is enhanced after left brake 20 has been isolated from the master cylinders.

As will be described in more detail below, the shutoff valve operates responsive to an indication that left wheel 22 meets a skid condition. Examples of a skid condition include a threshold wheel slip or wheel deceleration rate, a threshold skid slip deceleration value, and like. In an embodiment, shutoff valve 24 is a mechanical valve that is configured to be electrically activated. The particular type of valve used to implement shutoff valve 24 is not critical, however, in several embodiments, the valve should have an acceptably high response rate (e.g., 5-10 ms being typical).

In some embodiments, shutoff valve 24 may be configured with a suitable sensor (e.g., proximity sensor) which identifies if the valve is open or closed. This status may indicate that the shutoff value has jammed open or close, or has otherwise failed. This feature, which is not a requirement, is often implemented to provide additional failsafe measures.

If desired, a one-way bypass check valve 32 may be implemented to bypass shutoff valve 24. When anti-skid control is active, the pressure at the brake is typically less than the pilot requested, such that the pressure in the second conduit portion 30 is less than the pressure at first conduit portion 26. The bypass check valve 32 thereby insures that brake pressure at left brake 20 does not exceed the originating pressure (i.e., pressure present in first conduit portion 26) requested by the pilot. The bypass check valve 32 is often implemented in environments in which increased safety is desired (e.g., aircraft).

Actuator assembly 28 is shown coupled to second conduit portion 30 between shutoff valve 24 and left brake 20, and may be implemented using any suitable device which can modulate or otherwise regulate fluid brake pressure. For instance, the actuator assembly may be implemented using an electrically controlled master cylinder or an electromechanical actuator (EMA).

In some embodiments, shutoff valve 24 and actuator assembly 28 may be configured as separate components operating independently. Alternatively, the shutoff valve and actuator assembly may be integrated but still be configured to operate independently. Operating independently, in one embodiment, means independently controllable by control unit 44.

Implementing shutoff valve 24 and actuator assembly 28 as separate components has several advantages. For instance, different applications may require a shutoff valve and/or actuator assembly with different response times. Since these devices can be implemented as separate components, different types of combinations of shutoff valves and actuator assemblies are possible. Another example is that an integrated shutoff valve and actuator assembly is a more complex structure, thus having an increased cost over implementing these structures as separate components.

A further example of an advantage of operating the shutoff valve and actuator assembly independently is that applications which benefit from separately controlling these components may be achieved. Particular examples of such applications include aircraft touchdown protection and wheel de-spin at takeoff. These applications will be described in more detail in conjunction with later figures.

In an embodiment, the actuator assembly includes a relatively small master cylinder 34 (as compared to master cylinders 16, 18) driven by an electric motor 36 and ball screw 38. The electric motor may be coupled to linear actuator 40 which is displaceable to regulate fluid brake pressure within second conduit portion 30 at a desired time (e.g., when anti-skid control is active). The electric motor is typically structured to be driven in forward and reverse directions to effect forward and reverse displacement of the linear actuator for increasing and decreasing the brake pressure to left brake 20.

In some implementations, the volume of hydraulic fluid controlled by actuator assembly 28 is significantly less (e.g., ratio of 6-8:1) than the volume controlled by master cylinders 16, 18. This is commonly done to maximize the speed and efficiency of the actuator assembly.

Electric motor 36 may be implemented using a brushed or brushless DC motor, for example. Although either type of motor may be implemented, brushless DC motors (BLDC) commonly offer benefits not available in brushed DC motors. For instance, a BLDC motor typically offers faster RPMs, decreased moment of inertia, and improved thermal dissipation, among other features.

Actuator assembly 28 may optionally include position sensor 42 which provides position feedback data to a controller, such as control unit 44. This position feedback data provides information as to the position of various components of actuator assembly 28 (e.g., drive direction of electric motor 36, relative positioning of linear actuator 40, and the like).

One benefit provided by actuator assembly 28 relates to the relatively small hydraulic fluid demands required for operation when anti-skid control is active. The electromechanical linear actuator, for example, needs to reduce and reapply only enough pressure to correct the wheel skid, which means small volume fluid transfer during anti-skid control. These minimal hydraulic fluid volumes enable anti-skid protection without use of a central hydraulic system.

Another feature relates to the failsafe design of the system. Being limited to relatively small amounts of hydraulic fluid volumes means that actuator assembly 28 will typically not overcome pilot braking (or lack of braking), providing the system with relatively benign failure modes.

As noted above, shutoff valve 24 and actuator assembly 28 operate upon the detection of a skid condition, which is typically determined by control unit 44. The particular technique used to determine this skid condition is not critical to various embodiments of the present invention and most any device, component, or technique which can detect incipient skidding (or other skid condition) of the wheels of interest may be used. Examples of suitable techniques include wheel deceleration rate, wheel slip measurement, and skid slipping deceleration, among others.

These measurements usually require knowledge of the speed of the wheel of interest. If desired, wheel speed transducer 46 may therefore be operatively coupled to left wheel 22. The wheel speed transducer provides signaling to control unit 44, which in turn can calculate wheel speed and other measurements for determining the existence of a particular skid condition.

If desired, bypass switch 48 may be implemented to provide failure protection for the brake pressure control systems. To maximize failsafe conditions, the bypass switch is implemented as a manual switch which does not rely upon software intervention or control unit hardware for operation. The bypass switch is positioned to on override position by a pilot, for example, to selectively override operation of one or both shutoff valves 24.

Operating bypass switch 48 deactivates the shutoff valves, which consequently return to a normally open position permitting two-way fluid flow between master cylinders 16, 18 and the left and right brakes. With the shutoff valves deactivated, the system returns to manual pilot braking without anti-skid protection. Such protection may be restored by positioning bypass switch 48 in the normal operating position. A pilot may override the anti-skid protection in various types of circumstances. For instance, during takeoff or landing, the bypass switch may be used upon identification of a brake failure. Other uses include whenever it is desired to deactivate anti-skid protection, such as when the aircraft is parked, during aircraft maintenance operations (e.g., bleeding brakes), when the aircraft is proceeding at taxi speeds, and the like.

Control unit 44 is shown receiving power (via Power LH and Power RH), and may also be coupled to an aircraft display for displaying operational status of various system components.

Second brake pressure control system 50 is shown configured in a manner similar to first brake pressure control system 10. A distinction is that the components of the second brake pressure control system relate to controlling braking of the depicted right wheel, in contrast with controlling braking of the left wheel provided by the first brake pressure control system. Accordingly, with regard to second brake pressure control system 50, right pedals 52, 54 are used to effect braking in right wheel 56 via an associated right brake 58. The remaining components of second brake pressure control system 50 operate in a manner similar that which has been described above with regard to first brake pressure control system 10.

In accordance with an embodiment, operation of a multi-wheel brake pressure control system will now be described. It is understood that in many braking situations, a pilot, for example, will apply combination braking to both the left and right wheels 22, 56. For clarity, further operation will focus primarily on left wheel braking, but such teachings apply equally to both right wheel braking and situations involving combination braking of both the left and right wheels.

Consider first the scenario in which the first and second brake pressure control systems are installed on an aircraft. During a typical landing, the pilot or co-pilot, or both, will attempt to slow the aircraft by applying pressure to their respective brake pedals 12, 14, which in turn causes respective master cylinders 16, 18, to provide hydraulic pressure to left brake 20. If no skid condition is detected, the system operates as a typical pilot-controlled braking system. However, if control unit 44 detects a skid condition (e.g., developing tire skid in left wheel 22), the system will enter an active anti-skid control mode.

During this mode, the system will typically first isolate the pressure origination source (e.g., master cylinders 16, 18) from left brake 20. This isolation may be achieved by closing shutoff valve 24. After the master cylinders 16, 18 have been isolated, actuator assembly 28 is operated to reduce or otherwise modulate brake pressure in second conduit portion 30.

Reducing the brake pressure effectively releases left wheel 22 to prevent or recover from a skidding condition. In an embodiment, actuator assembly 28 repeatedly modulates brake pressure (i.e., brake pressure in second conduit portion 30) to an ideal pressure, and does not simply dump or otherwise remove all pressure from the second conduit portion. The actuator assembly optimally maintains brake pressure at the threshold of the skid, without exceeding this threshold. This action maximizes the skid coefficient, thus minimizing the stopping distance.

In accordance with various embodiments, the system will not return to manual braking from an active anti-skid control mode until the occurrence of one or more events. One event is that the skid condition no longer exists, which is typically determined by control unit 44. In this situation, shutoff valve 24 is deactivated and returns to the open position permitting two-way hydraulic fluid flow between master cylinders 16, 18 and left brake 20.

A closely related event occurs during the active anti-skid control mode, when the pilot partially or completely releases the brake pedals. This action will result in a drop in pressure in first conduit portion 26. If this pressure is lower than the pressure in second conduit portion 30 (such pressure being actively modulated by actuator assembly 28), one-way bypass check valve 32 will permit hydraulic fluid to flow from second conduit portion 30 to first conduit portion 26 so that pressure in the second conduit portion does not exceed the pressure existing in the first conduit portion. If the reduction of pressure in the second conduit portion 30 (resulting from pilot action) is sufficient to recover from the detected skid condition, then the system returns to manual braking and shutoff valve 24 is deactivated (opened).

A third event relates to the pilot overriding the anti-skid protection via bypass switch 48. Operating this switch causes the system to return to manual braking.

Yet another event originates in control unit 44 and is typically implemented to further maximize failsafe characteristics of the system. If the control unit detects a failure in a system component, then the anti-skid protection is deactivated (e.g., shutoff valve 24 and actuator assembly 28 are deactivated). This causes the shutoff valve to remain at, or return to, the normally open position and manual braking is restored or maintained.

A still further event is one in which the control unit 44 has detected an error with shutoff valve 24 (e.g., signal from a proximity detector associated with the valve). In this case, the shutoff valve is not operational and brake control should be disabled.

Various embodiments of the present invention have been described, but still further features may alternatively or additionally be implemented in accordance with alternative embodiments of the present invention.

As one example, actuator assembly 28 is not required to be implemented with the linear actuator and motor depicted in FIG. 1. For instance, the actuator assembly may alternatively be configured to include an actuator or other component displaceable to regulate fluid brake pressure within second conduit portion 30. Another alternative is to implement electric motor 36 using another type of power source (i.e., piezoelectric) coupled to the actuator. A piezoelectric power source is often utilized in applications requiring displacement of relatively smaller volumes of hydraulic fluid to effect desired braking One example is the braking system commonly utilized in unmanned aerial vehicles (UAVs). Regardless of the type of power source utilized, the power source is useful to effect displacement of the actuator for increasing and decreasing the brake pressure in the second conduit portion.

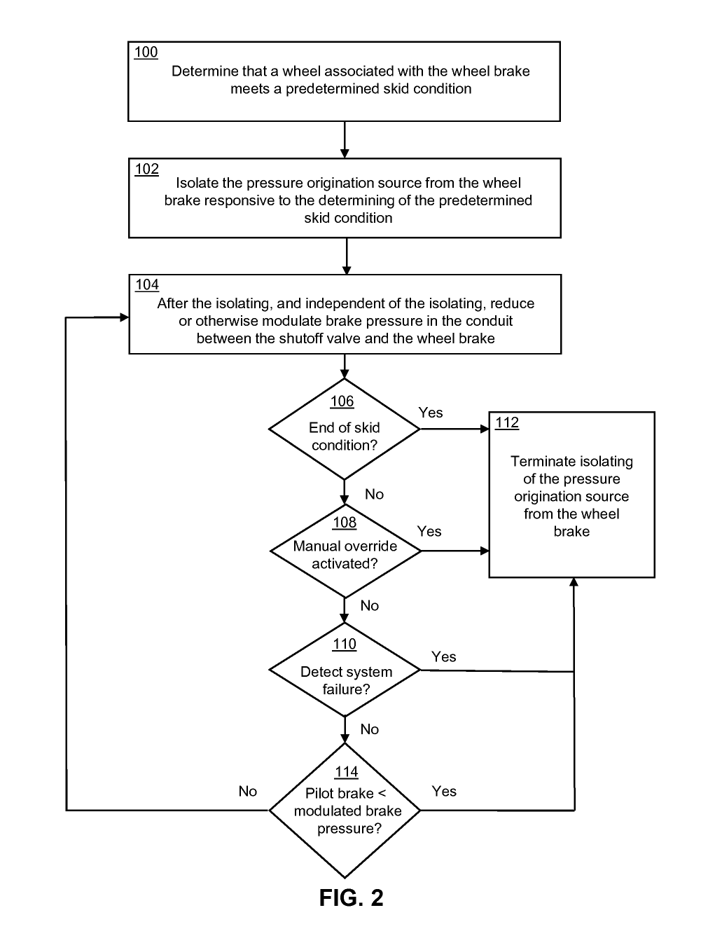

FIG. 2 is a flowchart depicting a method for controlling brake pressure in a brake system, in accordance with an alternative embodiment of the present invention. This brake system generally includes a discrete shutoff valve located in a hydraulic conduit between a pressure origination source and a wheel brake. Block 100 includes determining that a wheel associated with the wheel brake meets a skid condition. Block 102 includes isolating the pressure origination source from the wheel brake responsive to the determining of the skid condition.

After the isolating operation, and independent of this isolating operation, another operation includes reducing or otherwise modulating brake pressure in the conduit between the shutoff valve and the wheel brake (block 104).

At this point, one or more determinations may be made which indicate that anti-skid protection is to terminate. Examples include determining the end of the skid condition (block 106), manual override is activated (block 108), system failure is detected (block 110) or when the pilot requested braking is less than the modulated brake pressure (block 114). If none of these conditions has occurred, then control flows back to block 104. Otherwise, if one or more of these conditions is present, control flows to block 112 which provides for terminating the isolating of the pressure origination source from the wheel brake.

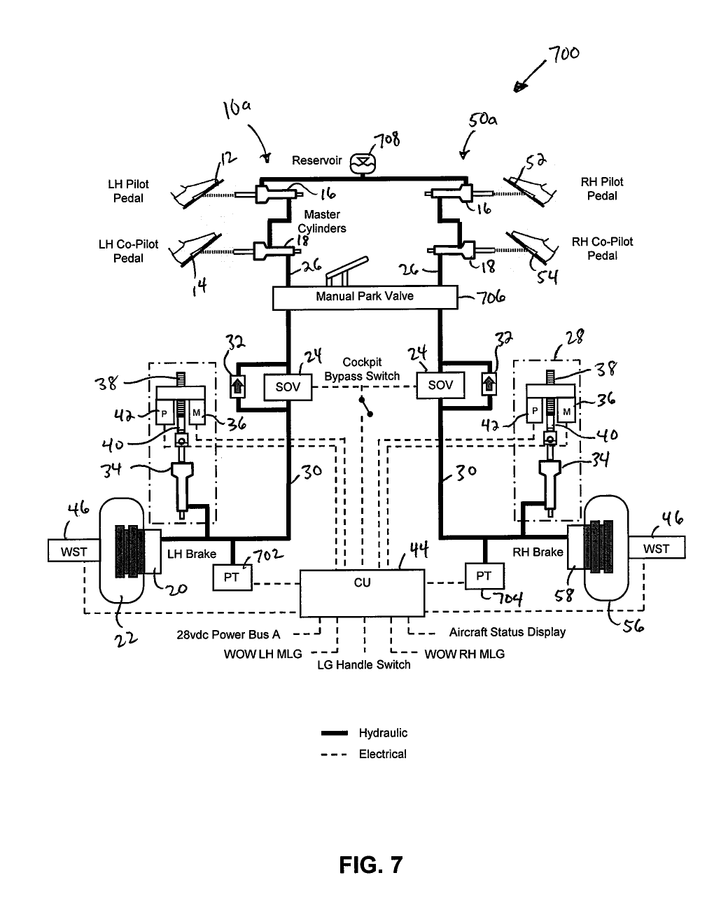

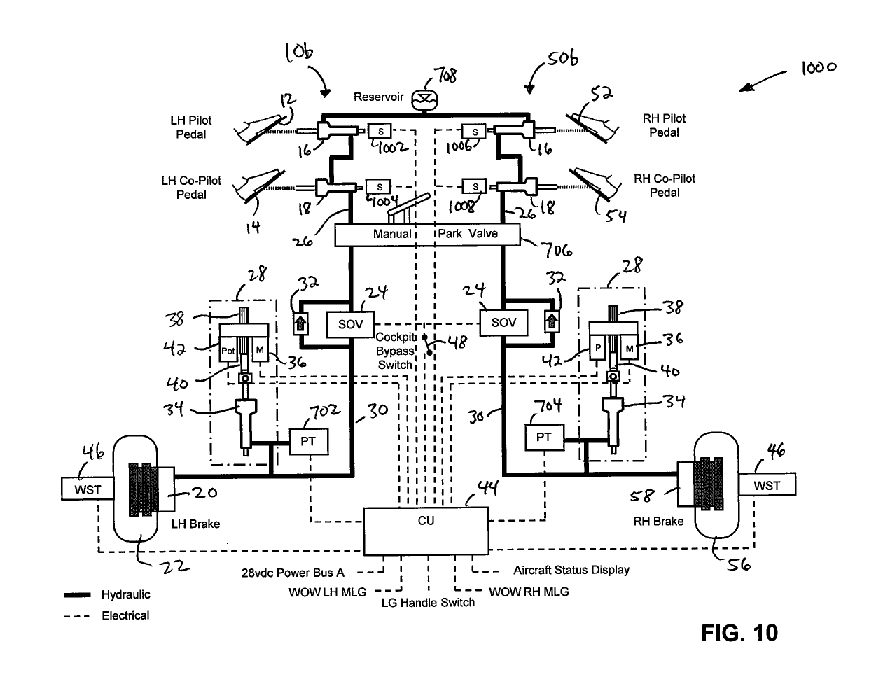

The specific examples depicted in FIG. 2 for terminating the isolation of the pressure origination source are exemplary, but additional alternatives are possible and envisioned by the present disclosure. One such condition relates to the scenario during which it is desired to obtain a skid condition. For instance, consider an aircraft proceeding at taxi speed, which is a speed at which there is minimal risk of tire damage if the wheel skids. Pilots generally prefer manual braking at low speeds, and sometimes intentionally lock one of the wheels (which anti-skid would try to prevent) in order to make a very tight turn. In the example condition of block 114, when the pilot backs off the brake to the point where the pressure in the conduit portion 26 is less than the pressure in conduit portion 30, fluid will flow back through the check valve 32. For example, if skidding starts at a braking pressure of 500 pounds per square inch (psi), the control unit 44 may later cause the actuator 34 to regulate or modulate pressure to about 300 psi. If the pilot backs the brake off to below 300 psi, the pilot is no longer requesting brake pressure above the skid level and fluid will flow through the check valve 32 until pressure on the brake side of the system is equal to the pressure the pilot is applying. At this point, the process goes to block 112 to re-open the shut off valve 24. In one form, this condition is determined in that the control unit 44 knows the relationship between pressure (using a pressure transducer) and position (using a potentiometer tracking the pedal or actuator position). Based on the characteristics of the brake, there is a defined relationship between pressure and actuator or pedal position. When the pilot backs off on the brake pedals, fluid flows back through the check valve 32 (exits the “isolated” system) and this relationship is broken. The control unit 44 then knows to re-open the shutoff valve 24. This condition functionally overlaps the “end of skid condition” (block 106). It works better in many cases because the actuator 34 may briefly try to reapply the pressure it is “losing” to the pilot as skidding stops-giving the pilot the sense that pressure it not reducing as requested. In one implementation, this condition detection utilizes a pressure transducer (not illustrated in FIG. 1, but may be similar to the sensor 702 of FIGS. 7 and 10).

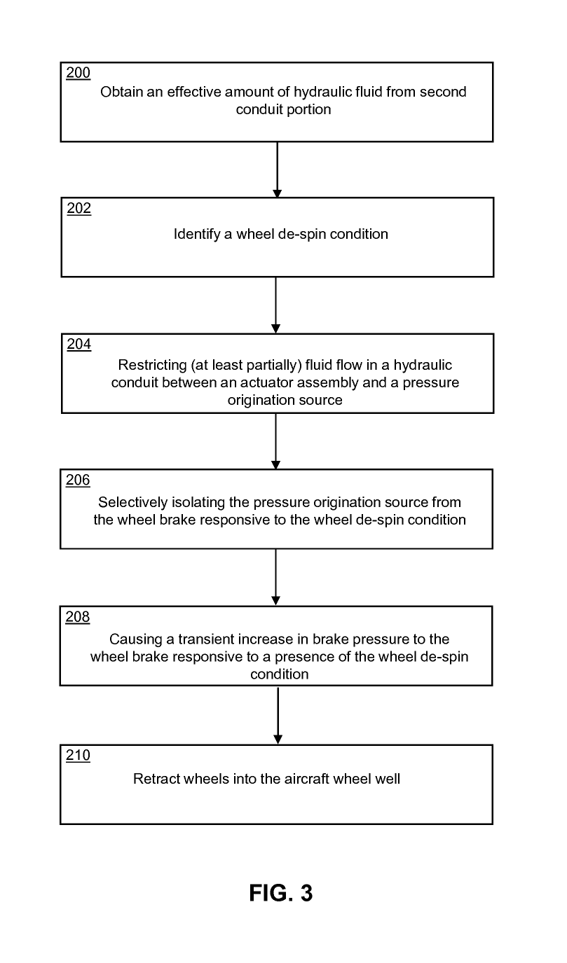

FIG. 3 is a flowchart depicting a method for providing aircraft wheel de-spin at takeoff, in accordance with an embodiment of the present invention. During a typical takeoff, the aircraft wheels (e.g., wheels 22, 56) are generally spinning as the aircraft progresses into its ascent. Retracting a spinning wheel poses a danger to the wheel well of the aircraft. If the spinning wheel/tire has debris or partially separated tire tread, for example, such items may damage the wheel well. Accordingly, it is desirable to affect braking to the spinning wheels after take off and prior to or during retracting of the wheels.

Block 200 includes obtaining an effective amount of hydraulic fluid from second conduit portion 30 (e.g., by actuating linear actuator 40). An effective amount is that which will provide sufficient pressure in second conduit portion 30 to effect transient or otherwise unsustained braking of an associated wheel.

Block 202 includes identifying a wheel de-spin condition. This condition may be an indication that the aircraft is partially or completely airborne following takeoff. This condition may be automatically determined (e.g., a particular weight on wheels (WOW) condition, aircraft speed, wheel speed, combination thereof, and the like), or it may be manually initiated.

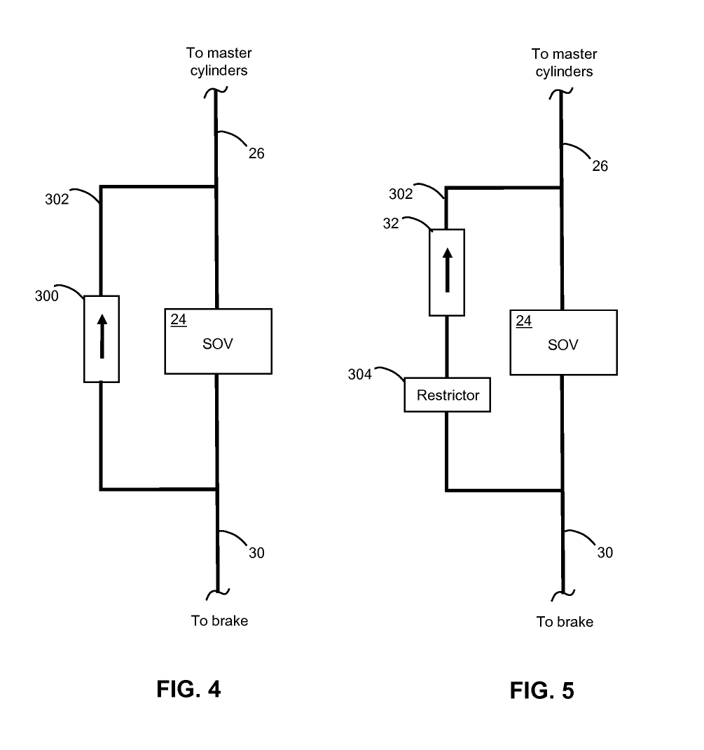

Block 204 recites restricting (at least partially) fluid flow in a hydraulic conduit between an actuator assembly (e.g., actuator assembly 28) and a pressure origination source (e.g., master cylinders 16, 18). Various techniques for achieving the desired restriction in fluid flow will be described in more detail in conjunction with FIGS. 4 and 5.

Optional block 206 recites selectively isolating the pressure origination source (e.g., master cylinders 16, 18) from the wheel brake (e.g., wheel brakes 20, 58) responsive to a wheel de-spin condition associated with the wheel brake. This may be accomplished using shutoff valve 24, for example. In some cases, operations of block 204 and/or block 206 are performed responsive to the wheel de-spin condition identified in block 202, but this is not a requirement.

Block 208 includes causing a transient increase in the brake pressure to an associated wheel brake responsive to a presence of the wheel de-spin condition. For instance, this increase in pressure causes left and right brakes 20, 58 to slow or stop associated wheels 22, 56. The increase in pressure may be achieved by actuator assembly 28 operating as a braking mechanism (not as an anti-skid device as in other embodiments) by driving linear actuator 40 forward to increase pressure in second conduit portion 30. This transient pressure increase is sufficient to stop wheel rotation since the brake does not need to stop the aircraft, but instead only needs to stop the inertia of the wheel and brake during a de-spin operation.

The operations of block 208 are typically performed after the operations of block 206 have been performed. This is because the isolation provided by shutoff valve 24, for example, facilitates the increase in pressure provided by linear actuator 40. In some embodiments, the isolation operations of block 206 are terminated after the desired transient increase in brake pressure (block 208) has been achieved. A specific example includes causing shutoff valve 24 to open after linear actuator 40 provides the desired transient pressure increase in second conduit portion 30.

Once stopped, the wheels may then be completed retracted into the aircraft wheel well (block 210). Note that some or all of the operations depicted in blocks 200 though 208 may be performed simultaneously, or substantially simultaneously, of performing the retraction operation of block 210.

FIGS. 4 and 5 depict various configurations for implementing a restrictor in accordance with embodiments of the present invention. In particular, these examples depict alternatives for implementing a fluid restriction in the conduit or other component of the braking control system shown in FIG. 1. Any of these techniques may be implemented to provide the restricting operations of block 206.

FIG. 4 is a block diagram depicting bypass check valve 300 located in third conduit portion 302. Bypass check valve 300 is similar in many respects to bypass check valve 32 (FIG. 1). However, one distinction is that bypass check valve 300 includes a restriction which inhibits or otherwise restricts fluid flow from a brake to the master cylinders. In this example, the third conduit portion is parallel to the conduit path which passes through shutoff valve 24. The restriction may be implemented as a reduction of the orifice through which hydraulic fluid flows.

During operation in accordance with one embodiment, shutoff valve 24 (if utilized) is closed to isolate the master cylinders 16, 18 from left brake 20, for example. Typically, the shutoff valve is closed responsive to a wheel de-spin condition, or other condition. Actuator assembly 28 drives linear actuator 40 forward to increase pressure in second conduit portion 30. Although bypass check valve 300 is open permitting upstream fluid flow (from linear actuator 40 to the master cylinders), the restriction in the bypass check valve causes a transient increase in pressure in second conduit 30 toward the brake. Recall that this transient pressure increase is sufficient to stop wheel rotation since the brake does not need to stop the aircraft, but instead only needs to stop the inertia of the wheel and brake during a de-spin operation. After this transient increase of pressure, the pressure applied by actuator assembly 28 will equalize via the restriction in bypass check valve 300.

The length of time at which the transient pressure increase exists is not critical. Typically, this operation does not result in sustained braking pressure, such as that which occurs during manual braking operations while the aircraft is on the ground. In a typical embodiment, the transient pressure increase exists for an amount of time (e.g., less than 1.0 sec.) which permits stopping (or slowing to an acceptable rate) of an associated wheel. Although possible, in many cases pressure is not increased repeatedly during a given de-spin operation. Utilizing a single pressure increase, or perhaps only a few successive pressure increases, helps insure that an unintended sustained pressure increase is not experienced.

As another example, if the restrictor is implemented in bypass check valve 300, a further benefit may be achieved by way of increased failure mode protection. Consider a scenario of shutoff valve failure (e.g., valve stuck in the closed position preventing or inhibiting manual braking). If the bypass check valve includes a restriction permitting limited two-way fluid flow (ordinarily the bypass check valve permits one-way fluid flow) between second conduit portion 30 and first conduit portion 26, pilot-applied brake pressure may reach the brake via this restriction. In this application, the bypass value is implemented using a restriction which permits limited two-way fluid flow between the master cylinder and brakes. In this example, the size of the restriction is typically selected to match the pressure needs for de-spin braking while still being responsive to pilot request for a reduction in braking.

FIG. 5 is a block diagram depicting restrictor 304 implemented separate from bypass check valve 32. In this embodiment, the restrictor is such that the restrictor is between the bypass check valve and brake, but parallel to shutoff valve 24. Restrictor 304 may provide the same or similar fluid restriction function as the restrictor implemented in bypass check valve 300 (FIG. 4). Further alternatives include locating restrictor 304 upstream from bypass check valve 32 (e.g., first conduit portion 26 or third conduit portion 302), second conduit portion 30, or combinations thereof.

In various embodiments, a typical restrictor (either restrictor 304 or bypass check valve 300 having a restrictor) will be present during manual braking operations. This restrictor will introduce a delay such that instead of pressure immediately flowing back to the master cylinders when a pilot reduces force applied to the brake pedals, there is a delay in pressure bleed off.

In some situations, this delay is discernable by a pilot releasing applied pressure to the brake pedals. Ordinarily, the delay causes minimal inconvenience to the pilot. However, to minimize the affect of this delay, a restrictor may be located in a path parallel to shutoff valve 24 (such as that depicted in FIGS. 4 and 5). During operation, fluid will typically only flow through bypass check valve 32 or 300, and associated third conduit portion 302, in situations during which anti-skid protection is active (i.e., shutoff valve 24 is closed) and the pilot has released pressure on the foot pedals. Since this an occasional event, the delay caused by a restrictor is not overly significant. Note that if restrictor 304 is located in first conduit portion 26 or second conduit portion 30, for example, then this delay would be experienced during each manual braking operation.

Yet another option is to implement a second shutoff valve, which may be configured similar to shutoff valve 24, in either first conduit portion 26 or second conduit portion 30. This second shutoff valve would be activated (i.e., closed) whenever the transient braking pressure is to be applied by actuator assembly 28.

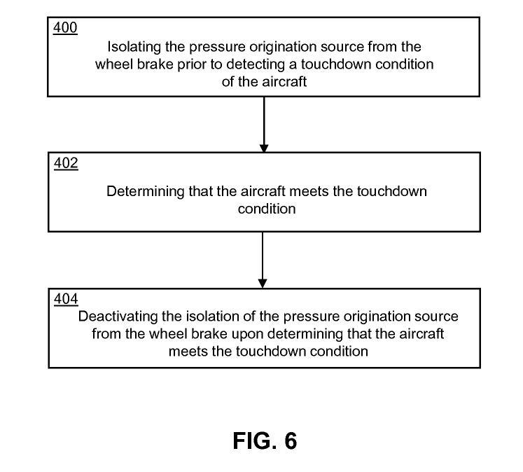

FIG. 6 is a flowchart depicting a method for providing touchdown protection for an aircraft with a brake control system, such as any of the brake control systems disclosed herein. In this embodiment, it is generally understood that it is desirable that the wheels of the aircraft be free-rolling upon touchdown and that the wheels be allowed to either rotate freely for a fixed period of time or reach a certain rotational speed before application of brake pressure or operation of anti-skid protection.

A typical aircraft permits foot pedals to control not only the rudder but braking as well. Rudder control is usually achieved by left-and-right axial movement of the foot pedals (e.g., pedals 12, 52), and braking is achieved by applying downward toe or rotational pressure on the pedals. During final approach to the runway, the pilot is actively manipulating the rudders, and in some cases, may inadvertently apply the brakes. This inadvertent braking may cause a skid condition upon touchdown. The embodiment of FIG. 6 may therefore be implemented to minimize or eliminate such inadvertent braking.

Referring to FIG. 6, block 400 includes isolating the pressure origination source from the wheel brake prior to detecting a touchdown condition of the aircraft. This operation is useful for preventing inadvertent braking during touchdown and may be achieved by activating shutoff valve 24, thus isolating master cylinders 16, 18 from the left and right brakes 20, 58.

Block 402 recites determining that the aircraft meets the touchdown condition. One general example of a touchdown condition is when the aircraft has partially or completely landed and it is desirable for the pilot to apply braking. The particular technique used for detecting touchdown is not critical to this embodiment. One example includes detecting wheel spin-up (e.g., via wheel speed transducer 46). Another example includes receiving a particular weight on wheels (WOW) signal at control unit 44. Either technique, or a combination of both techniques, may be used to identify aircraft touchdown and the need to deactivate shutoff valve 24, for example, thus returning the system to manual braking.

Block 404 includes deactivating the isolation of the pressure origination source from the wheel brake upon the determining that the aircraft meets the touchdown condition. This operation may be performed by deactivating shutoff valve 24 to permit manual braking.

Although the foregoing embodiments may be implemented using the exemplary series of operations described herein, additional or fewer operations may be performed. Moreover, it is to be understood that the order of operations shown and described is merely exemplary and that no single order of operation is required.

It is further understood that the foregoing embodiments having been described in the context with a two pilot aircraft. However, such embodiments also apply to other types of applications in which anti-skid protection, for example, is required or desired (e.g., vehicles, trucks, unmanned aerial vehicles (UAVs), and the like). Brake pressure control systems are disclosed with regard to two separate brakes and wheels, but greater or fewer brakes and associated wheels may be alternatively be implemented. Likewise, greater or fewer master cylinders may also be utilized.

Additional embodiments relate to the use of braking control systems for enhancing steering control. Such embodiments are useful in applications, such as aircraft, in which braking wheels are spaced relative to each other at such a distance that a single skidding wheel affects steering. Using aircraft as an example, at runway landing speeds, a single locked or skidding wheel may cause the aircraft to steer off the runway causing a catastrophic event. The various anti-skid techniques presented herein may be used to prevent such skidding events, thus enhancing aircraft steering.

In additional embodiments, volume assisted braking control systems and methods of use are provided. In these embodiments, a user or pilot effects braking by applying an angular displacement to the brake pedal or pedals. In other words, the pilot rotates the pilot's ankle forward or backward on the pedal. The pivoting of the pedal generally causes a master cylinder to displace fluid volume which in turns applies fluid pressure to the brake coupled to a wheel of the aircraft. As the angle of the pedal increases, it becomes more difficult for the pilot to apply pressure. In order to reduce the angle at which the pilot must rotatingly depress the pedal, some embodiments implement a volume assisted brake system independent of the anti-skid mechanisms described herein. By way of example, as the pilot begins to depress the brake pedal to request braking, the system automatically determines pilot is requesting braking and that a brake volume of the brake is not full and activates an actuator to displace the volume of the fluid in concert with the pilot's efforts to help fill the brake volume. Thus, the pilot does not need to press the pedal to as large a degree in order to effect braking. Furthermore, in some embodiments, once the brake volume has been filled, the actuator assisted volume displacement is not increased, but is maintained. This allows the pilot to increase or decrease braking with small angular movements of the pedal. If a skid condition is detected, the system behaves such as described in FIGS. 1 and 2. In some examples, once the pilot has returned the brake pedal to its non-braking position and the brake springs have returned the brake to its non-braking position, the actuator releases the additional volume displacement. The following description further describes and illustrates embodiments implementing this and similar or alternative volume assisted braking solutions.

Referring next to FIG. 7, a schematic diagram is shown that depicts a volume assisted brake control system 700 implemented with various aircraft components, in accordance with another embodiment of the invention. FIG. 7 includes many of the same components found in the system of FIG. 1. Those components that are the same as in FIG. 1 are labeled with the same reference number and in most cases function as described above. Some components are the same but function in a different manner in these embodiments and will be described below.

In a typical system 700 in which two aircraft brakes are controlled, first and second control systems 10a, 50a include the same or similar components. Accordingly, further discussion primarily relates to first brake pressure control system 10a, but such description applies equally to second brake pressure control system 50a.

With regard to first brake pressure control system 10a, left pedals 12, 14 are shown coupled (mechanically and/or electrically) to separate master cylinders 16, 18. Left pedal 12 is shown manipulated by the pilot and left pedal 14 is shown manipulated by a co-pilot. In a typical manual braking procedure, operation of either or both of the left pedals causes the master cylinders 16, 18 to displace a volume of the fluid in the hydraulic conduit (e.g., first and second conduit portions 26, 30) to build pressure on left brake 20, thus effecting braking of left wheel 22. As illustrated, reservoir 708 provides an integral fluid reservoir for both control systems 10a and 50a. It is understood that the both control systems 10a and 50a can have separate fluid reservoirs. All of the components needed to accomplish the antiskid controls, wheel de-spin and touchdown protection as described above remain in the system 700. It is noted that the figures and descriptions herein arbitrarily use dual master cylinders as the pressure origination source. The functionality and benefits of some embodiments also apply for any other pressure origination source including single master cylinders, alternate dual master cylinder arrangements, or even metered pressure from a central hydraulic system. Furthermore, it is noted that relative to the system of FIG. 1, the master cylinders 16 and 18 are in a series relationship with respect to each other, whereas the master cylinders 16 and 18 of FIG. 1 are in a parallel relationship with respect to each other. It is understood that both series and parallel arrangements function nearly the same in that the greater of the two pilots commanded brake pressure is applied to the wheel brake.

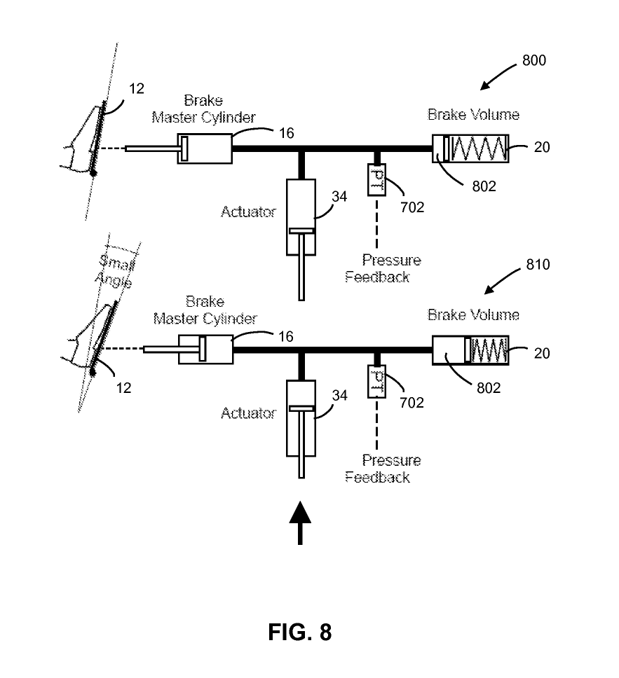

While describing several embodiments of the volume assisted braking, concurrent reference is also made to FIG. 8, which illustrates the foot position of the pilot while operating the volume assisted brake control system in accordance some embodiments. That is, referring also to diagram 800 of FIG. 8, prior to the pilot's request for braking, brake pedal 12 and actuator 34 are in a non-braking position. Diagram 800 also illustrates that a brake volume 802 of the wheel brake 20 is not full, e.g., nearly empty as illustrated). Relative to the system of FIG. 1, these embodiments include a sensor 702 (and 704) which is coupled to the hydraulic conduit (e.g., coupled to a portion of the second conduit portion 30) and that can detect an indication. In one embodiment, the indication corresponds to the amount of pressure of the fluid in the hydraulic conduit. Thus, the sensor 702 can detect pressure changes. Accordingly, in one form, the indication corresponds to an amount of displacement in the fluid volume. Sensor 702 is also in electrical communication with the control unit 44. Also illustrated in diagram 800 is the brake volume 802 of wheel brake 20. The control unit 44 may also be referred to as a controller is preferably an electronic control unit. For example, the control unit 44 is a microprocessor based device including control logic or circuitry and/or based on software, firmware and/or hardware.

In order to provide a volume assist during braking in order to allow the pilot to effect braking with less angular displacement of the brake pedal, as is illustrated in diagram 810 of FIG. 8, the pilot requests braking, e.g., by beginning to angularly or rotatingly depressing brake pedal 12, as normal. The initial depression of brake pedal 12 may be referred to as a mechanical request for braking. In turn, this causes master cylinder 16 (generically referred to as a pressure origination source) to displace a volume of the fluid at a first location in the hydraulic conduit. For example, as shown in diagram 810, the actuating portion of the master cylinder 16 moves to cause a volume displacement of the fluid. Sensor 702 detects a change in pressure of the fluid volume as the brake volume begins to start filling and sends an indication to control unit 44. In one embodiment, the sensor outputs signaling corresponding to pressure readings to the control unit more often than when an increase in pressure is sensed. In this way, the control unit 44 monitors the pressure readings of the sensor 702. In one embodiment, the sensor 702 is a pressure transducer that is responsive to increasing and decreasing pressure exerted thereon by the fluid volume; thus, sensor 702 detects an increase in pressure which the control unit determines as a mechanical request for braking. Thus, the sensor 702 provides pressure feedback to the braking control system. In other embodiments, sensor 702 is a linear potentiometer, a linear variable differential transformer (lvdt) (LVDT), a rotary variable differential transformer (RVDT), a rotary potentiometer, a flow sensor, a strain gauge or similar device. In any case, the sensor 702 provides an output indication that is usable by the control 44 to determine the presence of the mechanical request for braking. Also, based at least in part on the sensed values, the control unit can determine if the brake volume 802 is not full. For example, the control unit may be configured to determine or retrieve from memory, the pressure reading (or amount of flow or other metric) at which point the brake volume 802 is full. Although the approach is not described for the second brake control system 50a, sensor 704 is similar and structure and function to sensor 702. It is noted that the sensor 702 may be positioned to sense information at various locations in the hydraulic conduit even though it is shown as being at a point in the hydraulic conduit near the actuator 34 and the wheel brake 20.

Control unit 44 receives the indication from sensor 702, interprets it as a mechanical request for braking (the control unit determines the presence of the mechanical request for braking), and outputs signaling to actuator assembly 28. This signaling causes the actuator 34 to move which will cause additional displacement of the fluid at a second location in the hydraulic conduit. The additional displacement (shown in diagram 810 of FIG. 8 as the movement of actuator 34) occurs together with the displacement of the fluid caused by the pilot and master cylinder 16. In many embodiments, the actuator assembly 28 is under electronic control by the control unit 44. Due to the automatic and electronic control as well as component selection (discussed herein), the actuator assembly can be made to cause the additional displacement extremely quickly, i.e., nearly immediately after the pilot first depresses the brake pedal 12. Thus, the additional displacement is additive to the displacement provided by master cylinder 16. The additional displacement acts to fill the brake volume 802. For example, as is well known in hydraulic braking systems, the braking fluid must typically be displaced to fill the brake volume before actual substantial braking occurs. In some embodiments, the control unit 44 determines an amount of movement of the actuator 34 that is needed to help fill the brake volume 802 based at least in part on the indication from the sensor 702. In other embodiments, the control unit 44 determines a rate of actuation (e.g., velocity and/or acceleration) of the actuator 34 needed to help fill the brake volume 802 based at least in part on the indication from the sensor 702. In further embodiments, the control unit 44 determines an amount of movement of the actuator 34 and a rate of actuation that is needed to help fill the brake volume 802 based at least in part on the indication from the sensor 702.

Once the brake volume 802 is filled, the additional displacement is maintained. In one form, the actuator 34 is stopped by signaling from control unit 44 but not retracted. Thus, the additional displacement is maintained but not further increased. Accordingly, the actuator 34 has automatically assisted the volume displacement of the fluid in order to fill the brake volume 802 with less pedal depression than would otherwise be required. At this point, the pilot may make small adjustments to the angle of the brake pedal 12 which results in the desired amount of braking or release of braking. In this manner, according to some embodiments, the automatic volume assist does not provide more braking than the pilot is requesting. This is an important safety feature in many applications, particularly in aircraft applications. In order to determine that the brake volume is filled, in one embodiment, the control unit 44 monitors the output indications from the sensor 702. When the brake volume 802 is filled, the indications from the sensor will indicate a sudden increase in fluid pressure at the sensor 702. The control unit uses this sudden increase to determine that the brake volume has been filled. The control unit 44 then sends the appropriate signaling to the actuator assembly 28 to discontinue further additional displacement. In some embodiments, the sensor 702 is a pressure transducer that outputs indications corresponding to an amount of pressure on the transducer. Thus, the control unit can determine pressure measurements from the output of the sensor 702. Additionally, the control unit 44 may use the pressure measurements from the sensor 702 in the determination of the amount of additional displacement to instruct the actuator assembly 28 to provide. In some embodiments, the control unit 44 stops the additional displacement once a determined amount of movement of the actuator 34 is complete. In such case, the control unit 44 determines that the actuator should be moved a given amount or distance to provide a given amount of additional displacement. In one example, the control unit 44 know approximately what amount of actuation is needed when summed with the displacement provided by the pilot to fill the brake volume, and causes the actuator to move in this amount. In such cases, sensed pressure values may not be used in determination than the brake volume 802 has been filled.

When the pilot retracts the request for braking, e.g., by removing the pilot's foot from the pedal or releasing the angular depression of the pedal, in some embodiments, the additional displacement is continued to be maintained. The system does so, because the system is unaware if the pilot is just momentarily easing off the braking and will re-apply or if the pilot truly intended to release braking. Thus, in some embodiments, the additional displacement is maintained until the brake pedal 12 has returned to the non-braking position of diagram 800, then allowing the actuator to retract and thus the brake springs return the wheel brake 20 to the non-braking position where the brake volume 802 has been emptied. The control unit 44 sends the appropriate signaling to cause the actuator assembly 28 to return the actuator 34 to the non-braking position (see diagram 800).

At any time during braking, if an anti-skid condition is detected, the braking system behaves as described, for example, in connection with FIGS. 1 and 2. The volume assist functionality can work independently or together with the anti-skid, wheel de-spin and touchdown protection described above.

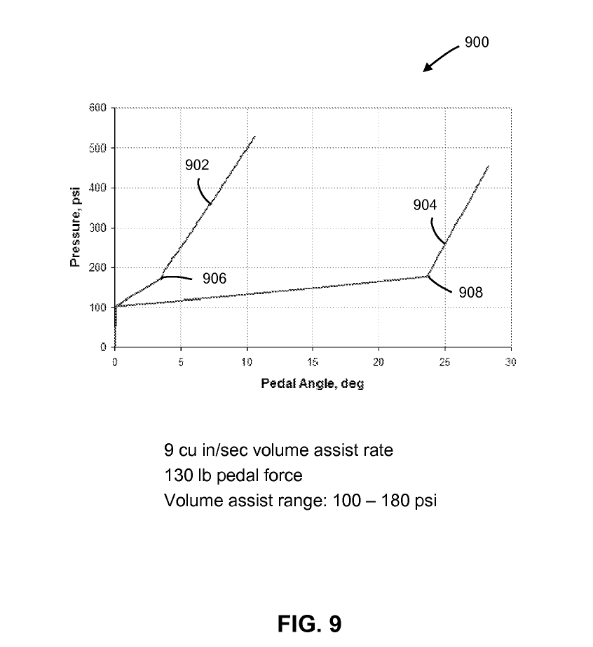

Referring next to FIG. 9, a graph is shown that illustrates an example of the reduction in pedal angle using the volume assisted brake control system in accordance with some embodiments. The graph provides pedal angle in degrees vs. pressure in pounds per square inch (psi). Line 904 illustrates the case where automatic volume assisted braking is not used. In this case, the pilot typically has to press the brake pedal about 23 degrees to begin substantial braking pressure. Line 902 illustrates the use of automatic volume assisted braking. As can be seen, the pilot only need depress the pedal to about 3 degrees to begin substantial braking. It is noted that points 906 and 908 indicate the point at which time the brake volume has filled. In this example, the volume assist was provided at 9 cubic inches/second, using an example commercial brake, 130 pound pedal force, and a volume assist range of 100-180 psi. Thus, the pedal angle using the volume assist results in a reduction of about 20 degrees of pedal angle to achieve the same braking pressure in this example. The use of the volume assist feature of several embodiments will always provide a reduced and more consistent pedal travel. The degree of the pedal travel reduction depends on many variables including the master cylinder and wheel brake characteristics present in the system. In some embodiments, by way of example, the pedal angle reduction while achieving the same braking pressure is between about 5 and 25 degrees, and in some embodiments, between 15 and 25 degrees. While these specific ranges are provided, it is recognized that other combinations of variables, other ranges of pedal angle reduction are possible.

In some embodiments, the automatic volume assist braking feature provides several advantages. Generally, the volume assist provides a reduction in pedal travel as discussed above. This can provide more efficient and comfortable force application by the pilot, particularly if the pilot has to hold the brake pedal at a certain braking position for a period of time. Furthermore, the pilot can more easily apply braking pressure through rotation of the pilot's ankle since the angle at which braking is effected is much smaller with the volume assist feature (e.g., the angle is reduced nearly 20 degrees in the example of FIG. 9). The only hardware changes for the system of FIG. 7 relative to that of FIG. 1 is the addition of the sensors 702 and 704. Other changes are software in the implementation of the control unit 44. Additionally, in some embodiments, the volume assist allows the pilot to be able to apply more pressure than otherwise possible given the same amount of possible pedal travel range. That is, the less pedal travel range is used to fill the brake, the more of the pedal travel can be used to effect braking pressure. This comes about because the volume assist allows larger brakes with larger fluid volume displacement requirements to be used along with a master cylinder supply source. Also, in some embodiments, the control unit 44 causes the actuator 34 to maintain the additional displacement once the brake volume has been filled; thus, the system never provides more braking than the pilot is requesting. Also, the volume assist functionality can co-exist and does not effect the functionalities provided by the anti-skid protection, wheel de-spin and touchdown protection features described herein.

Additionally, in some embodiments, the braking system 700 is designed such that adequate pedal travel is provided to effect a minimally acceptable (or regulated) amount of braking should the automatic volume assist feature fail. That is, if for any reason, the additional displacement is not provided, the pilot may manually effect the desired braking but this will be at a longer pedal travel. Other embodiments may not include this pedal travel design.

Also illustrated in FIG. 7 is the handbrake 706, which allows the pilot to pull the hand brake to maintain braking at a desired level without the need to continue to keep the brake pedal held at a particular angle. The handbrake 706 can also be used for parking or emergency braking. Accordingly, the volume assist features according to several embodiments are compatible with the use of the handbrake 706.

As described herein, the system works similarly for brakes 14, 16, 18, master cylinders 18, and sensor 704. Left and right brakes also function similar to that described above. It is also noted that as described above in connection with FIG. 1, the actuator assembly 28 is not required to be implemented with the linear actuator and motor depicted in FIG. 7. For instance, the actuator assembly may alternatively be configured to include an actuator or other component moveable to displace fluid volume within second conduit portion 30. Another alternative is to implement electric motor 36 using another type of power source (i.e., piezoelectric) coupled to the actuator. A piezoelectric power source is often utilized in applications requiring displacement of relatively smaller volumes of hydraulic fluid to effect desired braking. One example is the braking system commonly utilized in unmanned aerial vehicles (UAVs). Regardless of the type of power source utilized, the power source is useful to effect displacement of the actuator for increasing and decreasing the brake pressure in the second conduit portion.

It is noted that the embodiments of FIG. 7-8 operate most efficiently when used with a brake that does not degrade or wear significantly over time with use. For example, in some systems, with usage the brake volume 802 significantly increases over time. Thus, even with the volume assist, over time, the pilot will need to depress the pedal a slightly larger angle over time. That is, the benefits of some embodiments vary somewhat with the variability of the fluid volume of the hydraulic conduit increases (again, typically due to wear of the brake). In one embodiment, it is estimated that the system of FIG. 7 provides the most benefit when the volume of the brake does not vary more than 30-40% over its useful lifetime. Also, because of the fluid volume changes with brake wear, the resulting brake pressure for a given applied pedal angle will vary as the brake wears. A solution to this problem is discussed below with reference to FIG. 10.

Referring next to FIG. 10, a schematic diagram is shown that depicts an alternative volume assisted brake control system implemented with various aircraft components, in accordance with another embodiment of the invention. The system 1000 of FIG. 10 is identical in structure to the system 700 of FIG. 7, but includes sensors 1002, 1004, 1006 and 1008 coupled to each of master cylinders 16 and 18 of the first and second braking control systems 10b and 50b. Alternatively, the sensors 1002, 1004, 1006 and 1008 are coupled to each of the brake pedals 12 and 14 of the first and second braking control systems 10b and 50b. To describe the functionality of the sensors and corresponding feedback control, reference will be made to sensor 1002.

Sensor 1002 detects and outputs an indication of a position of the brake pedal during pilot depression of the brake pedal. In one embodiment, sensor 1002 is a position sensor that outputs an indication to the control unit 44. The control unit 44 determines the position of the pedal by corresponding this indication to a position of the brake pedal 12. Thus, the sensor 1002 provides pedal position feedback to the control unit and braking system. Depending on the embodiment, the sensor 1002 may be a linear potentiometer, a linear variable differential transformer (LVDT), a rotary variable differential transformer (RVDT), rotary potentiometer, a flow sensor, a pressure transducer, a strain gauge or similar device. In any event, the sensor 1002 outputs an indication that is usable by the control unit 44 to determine a pedal position of the brake pedal.

The control unit can use the pedal position indication to at least in part determine the presence of the mechanical request for braking. In some embodiments, the control unit 44 determines an amount of movement of the actuator 34 that is needed to help fill the brake volume 802 based at least in part on the indication from the sensor 1002. In other embodiments, the control unit 44 determines a rate of actuation (e.g., velocity and/or acceleration) of the actuator 34 needed to help fill the brake volume 802 based at least in part on the indication from the sensor 1002. In further embodiments, the control unit 44 determines an amount of movement of the actuator 34 and a rate of actuation that is needed to help fill the brake volume 802 based at least in part on the indication from the sensor 1002.

In one implementation, the control unit 44 contains a pre-determined relationship between pedal position and pressure to the brake, e.g., stored in memory). Thus, by using indications from sensor 1002 and sensor 702 (which in one embodiment provides an indication of pressure) the control unit can effect operation of the actuator assembly to ensure that an overall fluid pressure at the wheel brake that is substantially the same for a given position of the brake pedal regardless of wear of the wheel brake. For example, since the control unit 44 knows the pre-defined relationship, the control unit can determine an amount of actuator movement needed to ensure the same braking pressure at the pedal position over the life of the brake. In some instance, the control unit also determines the rate of actuation needed to effect the amount of actuation to provide the same braking pressure at the given pedal position over the life of the brake. With the pedal position feedback and using pressure feedback as discussed above, the braking system would assist in filling the brake volume and the additional displacement would be maintained when the brake volume was filled, but without pedal position feedback, the pilot would need to press the pedal at a larger angle to fill the brake volume over time. Accordingly, the control unit 44 uses the indication of the pedal position from the sensor 1002 and the pressure indication from sensor 702 to determine how much additional displacement is needed and how quickly it is needed in order that the overall fluid pressure at the wheel brake is substantially the same for a given position of the brake pedal regardless of the wear of the wheel brake. In many embodiments, this pedal position feedback eliminates the variability of the brakes which have a variable brake volume over their useful lifetime.

It is noted that in some embodiments, sensor 1000 may be used alone to determine the presence of the mechanical request for braking. For example, when the sensor 1002 outputs an indication to the control unit 44 indicating the pedal position is depressed relative to a non-braking position, the control unit 44 will then effect operation of the actuator 34 to provide the additional displacement to help fill the brake volume.

It is further noted that brake fill volume variability can include the tolerances in the brake 22 between the minimum and maximum running clearance. In some cases, these tolerances may be larger than the fill volume variation due to brake wear for some brake types. However, the solutions provided by the systems and embodiments, and variations of FIGS. 7 and 10, for example, will still provide improvement to account for this variability. However, with knowledge of such tolerances, embodiments utilizing both pressure and pedal position feedback can be configured to consistently account for these variances in the amount of additional displacement provided.

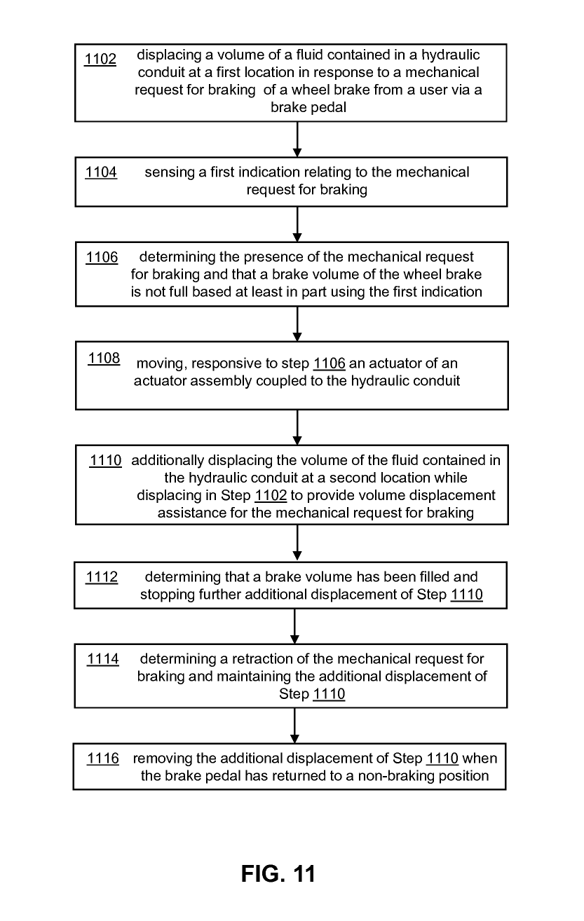

Referring next to FIG. 11, a flowchart is shown that depicts a method 1100 for volume assisting the pilot in braking an aircraft in accordance with several embodiments. It is noted that the method of FIG. 11 may be performed at least in part through use of the systems of FIGS. 7 and/or 10 and/or other systems and variations of these systems.

Step 1102 involves displacing a volume of a fluid contained in a hydraulic conduit at a first location in response to a mechanical request for braking of a wheel brake from a user via a brake pedal. For example, this may be accomplished by the master cylinder 16 when it receives a mechanical request through the angular depression of the brake pedal 12. In preferred form, the brake is an aircraft brake that controls braking through angular rotation and steering (rudder control) through axial depression of the brake pedal.

Step 1102 senses a first indication relating to the mechanical request for braking. In one embodiment, this may be accomplished through the use of sensor 702 (and sensor 704) and/or sensor 1102 (and sensors 1104, 1106 and 1108) as described above. For example, the indication may correspond to an amount of fluid pressure in the hydraulic conduit. In another example, the indication may correspond to a position of the brake pedal. In another example, the indication may correspond to both an amount of fluid pressure in the hydraulic conduit and a position of the brake pedal.

Step 1106 determines the presence of the mechanical request for braking and that a brake volume of the wheel brake is not full based at least in part on the first indication. For example, this may be accomplished at least in part using the sensor 702 and/or the sensor 1002 as described above. For example, the control unit 44 may interpret an increase in pressure (or flow or other value) as the mechanical request for braking and the value of the pressure (or flow or other value) may indicate that the brake volume is not full. That is, in some forms, the control unit is aware of the level of pressure (or flow pattern) that indicates the brake volume is full. In another example, the control unit 44 may interpret a change in pedal position from the non-braking position as the mechanical request for braking and given that it has been a particular length of time has passed since the last application of braking (and in some cases, the handbrake or other braking feature has not been activated), the control unit may determine that the brake volume is not full. Additionally, position measurements of the actuator 34 from the actuator assembly may indicate to the control unit 44 that the brake volume is not full.

Step 1108 moves, responsive to the determining of step 1106, an actuator of an actuator assembly coupled to the hydraulic conduit. In one embodiment, the control unit 44 automatically outputs signaling to cause the actuator assembly 28 to move the actuator 34. In one embodiment, the control unit 44 determines an amount of movement based at least on the first indication. In another embodiment, the control unit 44 determines a rate of the movement based at least on the first indication. The rate of movement may be the velocity of movement and/or the acceleration of the movement. In further embodiments, the control unit 44 determines both an amount of movement and a rate of the movement based at least on the first indication. In some cases, the movement of the actuator is determined based on multiple indications, such as pressure indications and pedal position indications. In some embodiments, the control unit 44 stores a pre-defined relationship between pressure and pedal position useful in determining and effecting the movement of the actuator.

Step 1110 additionally displaces the volume of the fluid contained in the hydraulic conduit at a second location during the displacement of step 1102 to provide volume displacement assistance for the mechanical request for braking. In one example, this additional displacement is the result of movement of the actuator 34. In some embodiments, the additional displacement is provided to ensure that an overall fluid pressure at the wheel brake is substantially the same for a given position of the brake pedal regardless of wear of the wheel brake.

Step 1112 determines that a brake volume has been filled and stops further additional displacement of Step 1110. In one form, the detection is performed by the control unit 44 by monitoring the measurements from the sensor 702. For example, once the brake volume is filled, there should be a significant increase in pressure (or reduction in fluid flow) with further fluid input (see points 906 and 908 of FIG. 9). At this point, the control unit 44 signals the actuator assembly to stop further movement of the actuator 34. This stops further additional displacement and maintains the additional displacement thusfar. In this way, a further increase in braking is provided only by the pilot, not the actuator 34, and thus, the braking system will not provide more braking than the pilot has requested. In other embodiments, this determination may be made through the knowledge that after completion of the application of a particular amount of additional displacement for a particular brake and system, the brake volume will be filled. In such cases, the determination may not necessarily be based on the monitoring of a sensor.

Next, Step 1114 determines a retraction of the mechanical request for braking and continues to maintain the additional displacement of Step 1110. The retraction is detected in one embodiment, by monitoring the pressure measurements (or reversal of measured flow) from the sensor 702. A decrease in pressure measurements or reversal of flow indicates a retraction of the braking. However, the additional displacement is maintained since the braking system does not yet know if the pilot intends to stop all braking or if the pilot is just easing off the brakes and will momentarily continue to brake. At this point, slight movements of the angle of pedal will increase or decrease braking. Again, in many embodiments, these slight angular movements of the pedal occur at an angular position of the pedal that is considerably less than if the automatic volume assist feature were not implemented.

Next, Step 1116 removes the additional displacement of Step 1110 when the brake pedal has returned to a non-braking position. For example, from decreased pressure measurements from the sensor 702, the control unit determines the pedal is at the non-braking position and signals the actuator assembly to return to the actuator to a non-braking position. Additionally or alternatively, the control unit 44 determines the pedal is in the non-braking position from measurements from the sensors 1102, 1004, 1006 and 1108 respectively. In some embodiments, step 1118 does not remove the additional displacement until the brake pedal has returned to a non-braking position, then the actuator can retract and the brake springs (illustrated in FIG. 8) return the brake to a non-braking position.

While the invention herein disclosed has been described by means of specific embodiments, examples and applications thereof, numerous modifications and variations could be made thereto by those skilled in the art without departing from the scope of the invention set forth in the claims.

What is claimed is:

1. A brake pressure control system, comprising:
a shutoff valve located in a hydraulic conduit between a pressure origination source and a wheel brake, wherein the shutoff valve is configured to selectively isolate the pressure origination source from the wheel brake responsive to an indication that a wheel associated with the wheel brake meets a skid condition;
an actuator assembly comprising an actuator displaceable to regulate fluid brake pressure within the hydraulic conduit after the shutoff valve isolates the pressure origination source from the wheel brake, wherein the actuator assembly is configured to operate independently of the shutoff valve and is coupled to the hydraulic conduit between the shutoff valve and the wheel brake, and wherein the actuator assembly is structured to effect displacement of the actuator for increasing and decreasing the brake pressure; and
a controller coupled to the shutoff valve and the actuator assembly, and is configured to determine if the skid condition has been reached, wherein the controller is further operable to control the shutoff valve and the actuator assembly based upon the skid condition.

2. The system according to claim 1, further comprising:
a bypass switch causing the shutoff valve to return to, or remain at, a normally open position responsive to user input.

3. The system according to claim 1, wherein the pressure origination source comprises a master cylinder.

4. The system according to claim 1, wherein the actuator assembly is configured to repeatedly increase and/or decrease the brake pressure while the shutoff valve is in a mode which isolates the pressure origination source from the wheel brake.

5. The system according to claim 1, further comprising:
a one-way bypass check valve located in the hydraulic conduit bypassing the shutoff valve.

6. The system according to claim 1, wherein the actuator assembly is separate from the shutoff valve and is coupled to the conduit between the shutoff valve and the wheel brake.

7. The system according to claim 1, wherein the power source comprises a motor structured to be driven in forward and reverse directions to effect forward and reverse displacement of the actuator for increasing and decreasing the brake pressure.

8. The system according to claim 1, wherein the power source comprises an electric motor.

9. A method for controlling brake pressure in a brake system comprising a shutoff valve located in a hydraulic conduit between a pressure origination source and a wheel brake, the method comprising:
determining that a wheel associated with the wheel brake meets a skid condition;
isolating the pressure origination source from the wheel brake responsive to the determining of the skid condition;
after the isolating, and independent of the isolating, reducing brake pressure in the conduit between the shutoff valve and the wheel brake; and
terminating the isolating of the pressure origination source from the wheel brake upon determining that the wheel no longer meets the skid condition.

10. The method according to claim 9, further comprising:
selectively terminating the isolating of the pressure origination source from the wheel brake, even while the skid condition is active, responsive to user input.

11. The method according to claim 9, wherein after the isolating, the method further comprises:
modulating repeatedly the brake pressure in the conduit between the shutoff valve and the wheel brake.

12. A brake pressure control system, comprising:
a shutoff valve located in a hydraulic conduit between a pressure origination source and a wheel brake, wherein the shutoff valve is configured to selectively isolate the pressure origination source from the wheel brake responsive to an indication that a wheel associated with the wheel brake meets a skid condition;
an actuator assembly coupled to the shutoff valve via a portion of the hydraulic conduit and comprising an actuator displaceable to regulate fluid brake pressure within the hydraulic conduit after the shutoff valve isolates the pressure origination source from the wheel brake, wherein the actuator assembly is structured to effect displacement of the actuator for increasing and decreasing the brake pressure; and
a controller coupled to the shutoff valve and the power source and configured to determine if the skid condition has been reached, wherein the controller is further operable to control the shutoff valve and the actuator assembly based upon the skid condition.

13. The system according to claim 12, wherein the actuator assembly is configured to operate independently of the shutoff valve.

14. A brake pressure control system for de-spin braking in an aircraft, comprising:
an actuator assembly comprising an actuator configured to couple to a hydraulic conduit between a pressure origination source and a wheel brake;
a restrictor configured to at least partially restrict fluid flow in the hydraulic conduit between the actuator assembly and the pressure origination source, wherein the actuator assembly is structured to effect displacement of the actuator for increasing the brake pressure; and
a controller coupled to the power source configured to cause the actuator assembly to create a transient increase in the brake pressure toward the wheel brake responsive to a wheel de-spin condition associated with the wheel brake.

15. The system according to claim 14, further comprising:
a shutoff valve located in the hydraulic conduit between the pressure origination source and the actuator assembly, wherein the shutoff valve is configured to selectively isolate the pressure origination source from the actuator assembly responsive to the wheel de-spin condition, and wherein
the controller is further coupled to the shutoff valve and is further configured to control the shutoff valve responsive to the wheel de-spin condition.

16. The system according to claim 14, wherein the actuator assembly is further structured to effect displacement of the actuator for decreasing the brake pressure.

17. The system according to claim 14, wherein the wheel despin condition indicates that the aircraft is at least partially airborne.

18. The system according to claim 15, further comprising:
a bypass check valve located in the hydraulic conduit bypassing the shutoff valve and permitting a second fluid flow path from the wheel brake to the pressure origination source.

19. A method for providing touchdown protection for an aircraft with a brake system comprising a shutoff valve located in a hydraulic conduit between a pressure origination source and a wheel brake, the method comprising:
isolating the pressure origination source from the wheel brake prior to detecting a touchdown condition of the aircraft;
determining that the aircraft meets the touchdown condition; and
deactivating the isolation of the pressure origination source from the wheel brake upon the determining that the aircraft meets the touchdown condition.

20. The method according to claim 19, wherein the deactivating permits manual activation of the pressure origination source to permit brake pressure to be applied to the wheel brake.

21. The method according to claim 19, further comprising:
isolating the pressure origination source without changing pressure applied to the wheel brake.

22. A brake control system, comprising:
a wheel brake having a brake volume;
a hydraulic conduit containing a fluid and coupled to the wheel brake;
a pressure origination source adapted to effect a first displacement of a volume of the fluid at a first location in response to a mechanical request for braking from a user via a brake pedal;
a first sensor configured to output a first indication relating to the mechanical request for braking;
an actuator assembly coupled to the hydraulic conduit and comprising an actuator, wherein the actuator assembly is structured to effect movement of the actuator for displacing the fluid; and
a controller coupled to the actuator assembly and the first sensor, wherein the controller is adapted to determine if the user is requesting braking and the brake volume is not full based at least in part on the first indication, wherein the controller is further adapted to effect operation of the actuator assembly causing the movement of the actuator to effect a second displacement of volume of the fluid at a second location while the pressure origination source effects the first displacement to provide volume displacement assistance for a given mechanical request for braking.

23. The brake control system of claim 22 wherein the first sensor comprises a sensor selected from a group consisting of: a flow sensor, a linear potentiometer, a linear variable differential transformer (LVDT), a rotary variable differential transformer (RVDT), rotary potentiometer, a pressure transducer and a strain gauge.

24. The brake control system of claim 22 wherein the first sensor is coupled to a portion of the hydraulic conduit.

25. The brake control system of claim 22 wherein the first sensor is coupled to the pressure origination source.

26. The brake control system of claim 22 wherein the first sensor is coupled to a brake pedal.

27. The brake control system of claim 22 wherein the controller is adapted to determine an amount of movement of the actuator based at least in part on the first indication and effect operation of the actuator assembly to control the movement of the actuator in accordance with the amount of movement.

28. The brake control system of claim 22 wherein the controller is adapted to determine a rate of the movement of the actuator based at least in part on the first indication and effect operation of the actuator assembly to control the movement of the actuator in accordance with the rate.

29. The brake control system of claim 22 wherein the controller is adapted to determine an amount of the movement of the actuator and a rate of the movement of the actuator based at least in part on the first indication and effect operation of the actuator assembly to control the movement of the actuator in accordance with the amount of the movement and the rate.

30. The brake control system of claim 22 wherein the first sensor comprises a pressure sensor and is adapted to output the first indication, the first indication corresponding to an amount of pressure generated by the first displacement and the second displacement.

31. The brake control system of claim 30 further comprising a second sensing configured to output a second indication, the second indication corresponding to a position of the brake pedal.

32. The brake control system of claim 31 wherein the controller is adapted to determine if the user is requesting braking and the brake volume is not full based at least in part on the first indication and the second indication.

33. The brake control system of claim 31 wherein the controller is adapted to utilize a relationship between pressure and position of the brake pedal to control operation of the actuator assembly to ensure that an overall fluid pressure at the wheel brake that is substantially the same for a given position of the brake pedal regardless of wear of the wheel brake.

34. The brake control system of claim 22 wherein the first sensor comprises a position sensor adapted to output the first indication to the controller, the first indication corresponding to a position of the brake pedal.

35. The brake control system of claim 22 further comprising a second sensor adapted to output a second indication to the controller, the second indication corresponding to a position of the brake pedal in response to the mechanical request for braking.

36. The brake control system of claim 22 wherein the controller is adapted to determine that the brake volume has been filled, the controller further adapted to stop further movement of the actuator to stop the second displacement of the volume, such that the second displacement will not provide more braking than is requested by the user.

37. The brake control system of claim 36 wherein the controller is adapted to determine that the brake volume has been filled based at least in part of the first indication.

38. The brake control system of claim 22 wherein the controller is further adapted to:
determine a retraction of the mechanical request for braking;
maintain the second displacement during the retraction; and
return, when the brake pedal has returned to a non-braking position, the second displacement of the volume of the fluid to a non-displaced state.

39. The brake control system of claim 22 wherein the brake pedal comprises an aircraft pedal in which the mechanical request for braking is provided by rotatingly depressing the brake pedal at an angle.

40. The brake control system of claim 22 wherein the pressure origination source comprises a master cylinder.

41. The brake control system of claim 22 wherein the actuator comprises an electrically controlled linear actuator.

42. The brake control system of claim 22 wherein the controller comprises an electronic control unit that is configured for automatic operation.

43. A method for braking in a brake control system comprising:
displacing a volume of a fluid contained in a hydraulic conduit at a first location in response to a mechanical request for braking of a wheel brake from a user via a brake pedal;
sensing a first indication relating to the mechanical request for braking;
determining the presence of the mechanical request for braking and whether a brake volume of the wheel brake is not full based at least in part on the first indication;
moving, responsive to the determining step, an actuator of an actuator assembly coupled to the hydraulic conduit; and
additionally displacing the volume of the fluid contained in the hydraulic conduit at a second location while displacing the volume of the fluid at the first location to provide volume displacement assistance for the mechanical request for braking.

44. The method of claim 43 further comprises determining an amount of movement of the actuator based at least in part on the first indication, wherein the moving step comprises moving the actuator in accordance with the amount of movement.

45. The method of claim 43 further comprises determining a rate of the movement of the actuator based at least in part on the first indication, wherein the moving step comprises moving the actuator in accordance with the rate.

46. The method of claim 43 further comprises determining an amount of the movement of the actuator and a rate of the movement of the actuator based at least in part on the first indication, wherein the moving step comprises moving the actuator in accordance with the amount of the movement and the rate.

47. The method of claim 43 wherein the first indication corresponds to an amount of pressure generated by the displacing the volume step and the additionally displacing the volume step.

48. The method of claim 47 wherein the sensing step further comprises sensing a second indication, the second indication corresponding to a position of the brake pedal.

49. The method of claim 48 wherein the determining step comprises determining the presence of the mechanical request for braking and whether a brake volume of the wheel brake is not full based at least in part on the first indication and the second indication.

50. The method of claim 48 further comprising using a relationship between pressure and position of the brake pedal to control the moving step to an overall fluid pressure at the wheel brake that is substantially the same for a given position of the brake pedal regardless of wear of the wheel brake.

51. The method of claim 43 wherein the first indication corresponds to a position of the brake pedal.

52. The method of claim 43 further comprising:
determining that the brake volume has been filled;
stopping further movement of the actuator; and
stopping additional displacement of the volume of the hydraulic conduit at the second location, wherein the additional displacing step does not provide more braking than is requested by the user.

53. The method of claim 52 wherein the first indication corresponds to pressure of the fluid in the hydraulic conduit, wherein the detecting step is based at least in part on the first indication.

54. The method of claim 43 further comprising:
determining a refraction of the mechanical request for braking;
maintaining the additional displacement of the volume of the fluid during the retraction; and
removing, when the brake pedal has returned to a non-braking position, the additional displacement of the volume of the fluid.

55. The method of claim 43, further comprising:
rotatingly depressing the brake pedal at an angle to provide the mechanical request for braking.

56. The method of claim 43 wherein the displacing the volume of the fluid at the first location is performed by a master cylinder.

57. The method of claim 43 wherein the actuator comprising an electrically controlled linear actuator.

58. The method of claim 43 wherein the performance of the determining step, the moving step and the additionally displacing step is automatically controlled by an electronic control unit.
